(19) United States
(12) Patent Application Publication
(10) Pub. No.: US 2016/0026960 A1
(43) Pub. Date: Jan. 28, 2016

(54) METHOD FOR MANAGING KNOWLEDGE WITHIN AN ORGANIZATION

(71) Applicant: Timothy Carnahan, Pompano Beach, FL (US)

(72) Inventor: Timothy Carnahan, Pompano Beach, FL (US)

(21) Appl. No.: 14/806,989

(22) Filed: Jul. 23, 2015

Related U.S. Application Data
(60) Provisional application No. 62/027,866, filed on Jul. 23, 2014.

(51) Int. Cl. G06Q 10/06

(52) U.S. Cl. CPC G06Q 10/06393

(57) ABSTRACT

A method to manage knowledge within an organization, a computer-readable storage device storing a plurality of instructions which, when executed by a processor, cause the processor to perform operations for managing knowledge within an organization and an apparatus for managing knowledge within an organization. The method generally is creating asset record documents; creating process record documents; mining the asset record documents and process record documents to create a corporate vocabulary; creating assigned tasks based on corporate vocabulary; linking assigned tasks, asset record documents, and process record documents to people, keywords, departments, subject matter experts, employees, business divisions, activities or projects or combinations thereof; and tracking assigned tasks, asset record documents, and process record documents by employee responsibility, location, department, project or status or combinations thereof.

### RELATED APPLICATIONS

This application claims priority to U.S. Provisional Application No. 62/027,866 filed Jul. 23, 2014. The entire contents of the above application are hereby incorporated by reference as though fully set forth herein.

### FIELD

The present invention relates to the field of systems and methods for managing knowledge. More specifically, the present invention relates to project based operating systems for managing knowledge within an organization.

### BACKGROUND

All organizations face challenges in managing explicit and tacit knowledge of their subject matter experts with respect to project management. For example, when a subject matter expert (SME) leaves a company, they take everything they know about the business process with them. To alleviate this, many companies take on an overlap period between the outgoing SME and the new hire that replaces them. However, if there are no new hires or the SME quits abruptly, knowledge is often lost and the next SME must start from scratch to recreate it.

An asset is a tangible or intangible item of positive economic value, which can be owned and managed, or controlled. Asset management (AM) is defined as “systematic and coordinated activities and practices through which an organization optimally and sustainably manages its assets and asset systems and the associated performance, risks, and expenditures over their lifecycles for the purpose of achieving its organizational strategic plan.” (Publicly Available Specification (PAS 55)—British Standards Institution, 2010)

Government agencies have a critical need to manage assets to meet oversight requirements and improve performance. Simply put, Asset Management is a driver of profitability and reduces waste. Management personnel need the information on assets in an organized, accessible fashion to understand the costs, performance, and risks from start to finish—the asset's lifecycle.

Total accountability is the quality management method developed to address the challenge of managing work across an entire enterprise, down to the activity, project, agency, division or employee level. Total asset accountability means total visibility and control of the organizational assets of governmental agencies. Such transparency and agility is critical to stay on top of operational activities, projects and budgets.

Whatever methodology used, it must be sustainable. Sustainability may be described as the capacity to endure. Many ambitious business improvement projects fail due to their complexity or the effort required by staff to maintain them. Even with asset management software, the challenge of allocation and control can be daunting and expensive without further automation.

Public sector organizations gain the most value by managing all assets—physical, financial, human, information, and intangible assets. Asset Management applications support planning, building, and commissioning of assets; asset visibility and performance; optimized asset operations and maintenance; and risk management. An integrated information system can readily provide operational and financial data for the assets managed.

Physical assets include fixed assets and current assets. Fixed assets are equipment, buildings and infrastructure, which are frequently depreciated. Information technology (IT) assets such as hardware and software and networking infrastructure can be managed as fixed assets. Financial assets are those which can be converted to cash, such as inventory, accounts receivable, prepaid accounts, and bank accounts.

Digital assets include text, graphics, video or other media in digital format. Digital assets may also exist in hard copy but the reference file itself is frequently viewed as the asset, and information is associated with the digital record. For digital assets, easy search and retrieval is important. These records might include letterhead, templates, employee manuals, proposal templates, technical documentation, vacation requests, vendor contracts, bill of sale, lease agreements and proprietary documents.

Intangible assets such as Intellectual property (IP)—patents, copyrights, accreditations, certifications and templates contribute to the true value of the business.

Software and hardware asset management poses a unique set of risk and cost challenges including licenses, leases, utilization, renewal, and maintenance fees but they can be handled easily with the right system.

Secure assets are another subset of assets, which must be treated differently, like employee records. Control procedures are required for management of confidential documents, proprietary information or those where access is controlled by law. On demand compliance reporting against these records should be enabled.

Management control over the agency assets is critical to maximize their value and planning For example, The Government Accounting Office (GAO) identified three leading practices for fleet management. These practices are: (1) maintaining a well-designed fleet-management information system (FMIS); (2) analyzing life-cycle costs to inform investment decisions; and (3) optimizing fleet size and composition. GAO identified these practices based on views provided by recognized fleet experts and determined that the practices align with legal requirements and General Services Administration (GSA) recommendations. Of the agencies reviewed, none capture all of these elements and some were not integrated with other key agency functions. As a result, agencies may not have full information with which to make vehicle replacement and procurement decisions. (Federal Vehicle Fleets: Adopting Leading Practices Could Improve Management. GAO-13-659, July 2013)

To survive, organizations must make the most of the value of the asset and track activities related to the assets throughout their lifecycles, to make sure they align with the organization's strategic and operational objectives, including: (1) optimize return on assets; (2) ensure compliance with safety, health, performance and environmental rules; (3) maximize uptime, reliability, useable lifetime; and (4) utilize the organized information available to improve.

### Prior Art

While there are attempts in the prior art to capture tacit knowledge from these SMEs through file sharing and project support software, such as Dropbox™ Basecamp™, and others, they lack knowledge management and process library capabilities. Further, while some like Evernote™ have document storage and collaboration features for knowledge management, they are not project-based and are not able to integrate financial information. They all lack seamless functionality and require exporting, interfacing or integrating data to other packages, which adds costs and complexity.

There is a need for something better than simple cloud computing or asset management packages. A platform is needed that provides an interactive command and control center, enables local and remote teams to communicate and collaborate and create most effectively in one project centric system, and captures the knowledge in the system and makes it usable.

As such, there is a need for a single integrated business software that offers a project-based operating system that integrated knowledge management into the everyday work flow it employees without the need to export, interface or integrate data with other software or packages.

### BRIEF SUMMARY OF THE INVENTION

It is the object of the present invention to address several challenges in previous attempts to manage knowledge on a project basis. The present invention is a project based operating system that provides total integration of business office functions that supports structured, accessible, reusable content in a process library where reference documents are stored for reuse, and continuous improvement.

The present invention manages all enterprise assets, including but not limited to facilities, equipment, fixed and consumable assets, IT hardware and software, intellectual property, processes, procedures, templates and any other identified assets which are critical to operations. It keeps all the information in one place for management to execute timely decisions in order to balance risk, cost and benefit of assets over their life cycles. It allows the user to link people with assets, and keep a record of chain of custody to provide traceability and accountability and reduce asset leakage. It provides for critical linkages of those assets to location, business divisions and projects or activities. It supports immediate and user friendly lifecycle management of the assets, including acquisition, maintenance, assignment, and disposal, and the management of risks during this process by providing exception-based reporting and alerting functions. It enables performance metrics for each asset, such as maintenance cost, performance, reliability and failure rates. Activities such as asset utilization rate can be benchmarked against industry best practices to determine how the business is operating against its peers. It views or inputs information and initiates activities through a single, secure, interactive web portal by computer, smart phones, tablets or new mobile business devices. It provides an Enterprise level of security through default or customized privacy settings. It is scalable and can support any size business or as many users without sacrificing performance. It offers the option for Cloud delivery, which provides significant reductions in infrastructure capital and operational costs and a primary disaster recovery and business continuity solution.

The present invention allows maximization of the value and accessibility of Subject Matter Experts (SME's), by linking them to the Corporate Vocabulary (described below) to create a process library. The present invention offers total accountability to enable management oversight of a huge number of activities in a multi-tiered organization. It can manage across projects and teams to react, reprioritize and integrate changes in real time.

The present invention E2P (Email to Project) works with existing Microsoft Exchange Outlook as a part of the system, eliminating information silos and black holes. By using the E2P tool, the user can create or update asset records within everyday operations. For fixed physical assets a record would be set up on acquisition or creation. Against this record, location, usage, problem records, maintenance, upgrades and disposition can be tracked, along with associated costs and asset information. Shipping costs and vendor information and other documents are captured and linked.

The user has the ability to create asset systems, or groups of assets that make up a system, such as a transmission network or a vehicle fleet. The user can then focus on sustained performance, cost, and risk optimization of those asset systems. This approach allows a quick view of the total costs of that system, without having to look at the individual parts and add them together. Asset systems provide an efficient way to manage a group of assets, which are interlinked.

When digital assets such as processes, templates or work procedures documents are created in the agency, they are stored as asset records in the document library, linked to keywords in the Corporate Vocabulary (described below) departments and Subject Matter Experts (SME's). All processes and procedures are stored in the Process Library for staff reuse and refinement. Reuse of best of breed practices supports continuous improvement.

Activities against these systems are managed in a project-based structure. An HR manager might use the E2P function to assign an activity (project) to update the health insurance information for the coming year. The hours used to perform the work are captured against the final product, which becomes an asset to be managed, with SME's and maintenance information recorded.

For intangible assets, a patent or industry certificate of expertise can be scanned and stored, with any renewal information. A fire inspection record can be stored, with alerts as to when it should be renewed. The value is recorded as well as any risks associated with their expiration. The document proof is available quickly and easily when needed.

For example, using a standard template, an employee could use an email to create the asset record of a new computer from a template and associate the technical manual and the warranty. The location, the owner and the software licenses associated with that machine would be recorded. For items requiring regular attention, like license renewals, alerts and reminder notices would be defined. A maintenance record is then created from a template, and all maintenance, problem records and patches would be captured going forward.

The software platform can track assets by employee responsibility, location, department, project and status. Summary reports across the agency are contained on one screen, with drill-down capabilities.

This information can be viewed through the web portal to determine whether a vehicle or machine is in use, in inventory and whether it is available for reassignment. Assets are visible quickly and easily by specific asset, asset type, agency or division or location. Authorized personnel can issue the order to move an asset immediately and generate the documentation to set the transfer in motion.

Knowledge centric organizations understand that tacit (experiential, unwritten, institutional) knowledge held by staff is one of their greatest assets and must be managed and maintained. Employees with critical skills and experience may be temporarily unavailable or later leave the company. This knowledge can be one of the most valuable types of assets the business has. Knowledge captured and linked to Corporate Vocabulary (described below) identifies critical business information and ensures it is made explicit (documented) and stored in a usable format.

Knowledge Management ensures that intellectual capital is indexed and made readily available in a secure fashion. Information is moved out of the ‘dark corners’ of the organization—email inboxes, file shares and team rooms. Finding the right document, email, template or billing information is certain and fast. Versioning allows visibility to modifications and new processes. E2P allows templates to be retrieved, forwarded and attached to projects quickly. In reverse, files from the projects are moved to the Document Library.

The present invention leverages a company's best assets by creating a Subject Matter Expert (SME) mapping to skills, processes, projects and files. Digital assets can be assigned ownership by an employee or department. For a contract or regulatory compliance document, this might be legal staff. For technical or process documents, this could be a subject matter expert who is responsible to maintain its accuracy and currency. This mapping increases accountability and lets workers find help quickly.

Knowledge Utilization incorporated through an improved implementation structure integrates the stored assets contacts into everyday work activities, working toward a paperless office. Control of secure assets is improved with the full management capabilities of the present invention. Secure assets might be controlled substances and weapons requiring control and reporting or documents deemed confidential with limited access rights.

Standard format reports are available in customizable familiar formats and dashboards. Asset reports can include notifications against expirations, renewals and replacement criteria or alert the appropriate stakeholders to low inventory. Defined reports, such as form DD1149, are available on command. A complete audit trail or financial tracking of lifecycle costs can be retrieved with drill-down capabilities.

A company may use the alerts and powerful notification system to manage routine maintenance for physical and digital assets. Real-time, standardized and custom reports of assets, their values, costs and activities are automated and available to staff members as well as management or the client, without labor intensive paper status reporting. Reports can be filtered to a specific task, activity, location, employee or team.

Secure access rights to view, edit, delete, and administer assets are created for security and auditability. Maintenance schedules for physical assets are easy to follow, with visibility of upcoming activities and tracking of repairs and upgrades. The user can readily see the asset inventory and where it is over or under. Maximizing consumables or spare parts inventory is a significant cost saving measure.

Using project-based methodology, activities required for the asset such as cleaning, transportation and tuning, which may otherwise be lost in operational budgets are tied to the asset itself. A full featured AM system records all the life time costs, including installation, maintenance, upgrade, and disposal.

Work orders or staff requests, can be generated and recorded while viewing the records. These orders are then tracked to completion in the software, giving total accountability to all involved. This type of precision management reduces the risk of failure.

The system can track maintenance of digital assets, usage and how dated they are. An employee manual or contract template, which has not been updated in six months or a year, depending on how fast your business moves, is probably outdated. References which are no longer used can be archived, reducing clutter in the system.

Once all contracts, lease agreements and retainers are set up as assets, the system allows the business to track status and usage of metered services. Renewing recurring contracts on time is assured with preset notifications and alerts. This functionality is very valuable for software license management or IT hardware leases. For customer contracts, itemized invoices for time used over contracted amounts are sent automatically.

The present invention integrates all its projects based tools to manage an asset during its “maintenance” or “problem” or “discussion” phase. So, all problem records, help-desk calls or history about a particular asset is documented. Email would be used to enter time on an asset or capture expenses. This could be the revision of a standard template, maintenance on a truck or problem resolution for a piece of software.

This maintenance management makes true cost of ownership immediately visible and provides life cycle costing with no added effort. This data can be used for procurement decisions going forward and helps create a learning system—identifying best performing assets and reuse information. Usage and problem data linked to the record assist in replacement decisions.

At end of life, physical assets can be reallocated, reused, scrapped, refurbished or sold. The system will prevent ‘lost assets’ and provide auditability of proper disposal. Compliance reports satisfy environmental regulations, which demand deconstruction or mandated disposal methods.

The present invention may use a Web based portal to gain the ability to collaborate with others and manage assets and activities via Smartphone or any Internet device with encrypted access. The interactive portal enables decentralization of management responsibilities while maintaining overview and control. Interactivity allows owners to act on the information they are viewing—make assignments, change, add new tasks.

The present invention allows users to make quick and accurate decisions with all the information needed every day or in a crisis or emergency situation. Authorized users of the system can re-allocate critical assets quickly, in real time competitive or emergency situations, with full notification to all. Access is immediate through the report portal to background documents, emails, issues or work products under document management. Managers can track a document or activity through all its steps—including visibility of delayed approvals or bottlenecks. Oversight of the task or activity flow identifies best practices and the most efficient performers, enabling benchmarking and creating a learning organization.

Active monitoring enables management to assess programs and projects in such a way that they can rapidly take proactive action. Reporting views support interactive filtering and reallocation of assets for different analyses.

When Management takes a corrective or steering action, e.g., reprioritizing a project or implementing a change, the staff members' dashboards reflect these decisions, keeping everyone on the same page.

Real time or defined period reporting is available instantly for audits or banking requirements.

The present invention provides scalability and usability in viewing, managing and reporting on a large, dynamic workforce. It includes built-in financial functionality where cost information is entered at the user or worker level to facilitate budget and time estimation for activities. Workers mark completion and input their time into the system of the present invention to provide immediate, real-time reporting against the activity and project estimates. Finally, the present invention crosses the chasm into the financial capabilities and allows for a full financial system with invoices, asset management and payroll - - - all that can be generated within the system's architecture, with the ability to drill-down for any backup information.

The present invention offers public and private sector flexibility. For example, it can be use in the health industry as a “Case Management” system or allow a small business to grow and achieve ISO 9001:2008 certifications. For example, every document is assigned a unique number and when a user prints the document that number is in the document header/footer. The document can be searched based upon the number. As such, printed material can be connected back to the original electronic version.

The present invention includes mobile support for “on-the-go” and remote workforce. The system allows remote log-in, in order to access the system and sync information from wherever the user is located using smartphones.

Formal meetings are not always practical, cost efficient or appropriate to the immediacy of today's dynamic projects. The Web based portal or the present invention enables local and remote teams to communicate and collaborate with others and access the knowledge base and process library with encrypted access via computer, Smartphone, tablet or any Internet device. This interactive portal empowers employees to view and act on information.

The present invention offers unparalleled expertise in security and SSO “Single Sign-On and can support PKI Authentication—the strongest possible method for SSO. It meets other “standards, policies and certifications” such as “HIPAA”. An Enterprise level of security is installed through default or customized privacy settings. The present invention provides secure access rights to view, edit, delete, and administer assets to ensure security and auditability. Backups and disaster recovery are built into a cloud-based installation.

The present invention makes it possible for management to see what each team member is working on, what progress they're making and how much time they're spending on their work. The present invention has a timesheet function that makes it possible for each employee to monitor their own workload and align their performance with an organization's goals. Each time a task is updated, time spent on that task is automatically calculated in the timesheet. The Timesheet allows employees to view what they worked on and how much time was spent on it each day.

The present invention allows you to see what type of work has been accomplished and how much it cost the company to pay an employee to do that work. While this may seem a bit unfair to some in the beginning, when employees are able to view their work, it becomes an eye opener. Employees generally don't realize how much they are accomplishing and with this information they may ask for a justified raise. Additionally, employees may realize they are just barely getting things done or there is just one thing they don't do that well. The benefit is that now they can solve their own problem, enhancing the overall organization.

The government is changing the way contracting is achieved. They want to give incentives for meeting a standard and disincentives for not meeting a standard. The motivation for a contractor is to exceed the standard and make more money. A second shift in the government is not to tell the contractor how to do things but to give the contractor a desired outcome and allow the contractor to do it their way in hopes of spawning innovation.

Performance Based Contracting (PBC) done properly spurs excellent Knowledge Management (KM) techniques among stakeholders and contract staff. While staff select a specified service to complete the government's desired outcome, the present invention assigns SMEs to each required service. The SMEs review the work performed and set up templates for use the next time this required service is used; even take feedback on the required service to improve it. This is where PBC can foster knowledge management and spawn a learning organization. The present invention captures, reuses and refines required services. The required services or categories are set up by the PM in the beginning of the contract. The present invention provides management tools to report usage and allow merging of two services into one. Over time, the Project Manager (PM) and Government Contracting Officer Technical Representative (COTR) will have a list of required services mapped to SMEs for performance measuring and creating a learning organization.

Why create a learning organization? The need for learning organizations is due to business becoming more complex, dynamic, and globally competitive. Excelling in a dynamic business environment requires increased understanding, knowledge and preparation. Whether utilizing a balanced scorecard or simply trying to effectively monitor contractor performance, the government needs straightforward tools like the present invention to build a learning organization. The present invention offers total accountability among government stakeholders and contract staff through its integrated project management, timesheet management, and automated time utilization reporting. Building toward a learning organization requires that internal employee performance be monitored and measured. Following that, learning can truly occur as information sharing becomes a participative process from all key leaders within a PBC.

The present invention is a complete task management system with email and text notification—everyone knows exactly what to do and management is given a total accountability of work. While the present invention is extremely complex, during use it unravels itself in such a way that a user can see exactly what you need to do in order to contribute to the successful completion of a project. The present invention, from project view, may have 10 tasks and each task may have multiple assignments where threaded discussions take place in a virtual space. What that means is the present invention puts bookmarks where your responses are or need to go in the discussions. This allows discussions to take place with two or more staff remotely and at different times. The present invention gives you a map (called Assignment Inbox/Outbox) of all assignments and those assigned out. All that is required is to just go back through the threaded discussion and answer each one, completing the task at hand.

The present invention fosters innovation by encouraging the free flow of information with project communication through the present invention's exclusive Email to Project (E2P) tool. This feature takes emails and attachments, and transforms them into assignments and files them with the appropriate project so that all team members can read them, react, comment and respond. The chaos of a cluttered mailbox is gone—no more storing emails locally where they can be lost, misplaced or deleted.

The present invention also allows a user to manage all entries to a threaded discussion so that the evolution of an idea is readily available for review by all authorized personnel. The user may accelerate by email or smartphone, the address book attached to each project that stores essential contact information for everyone working on a project. The present invention makes it easy to communicate with anyone, anywhere, anytime.

The present invention allows users to make assignments clear to each staff member and identify when they're due. Whenever an assignment is created, automatic notification via email alerts the team member of the assignment. The present invention allows a user to schedule notifications to remind team members when a task is due or send an immediate notification about a specific item.

When disaster strikes, a user might not be in their office. It is possible for all computers, servers and all knowledge to be gone in seconds; however, the present invention is built on redundant datacenters in different places in the U.S. for continuity of operations. The present invention allows for management of remote staff, that being a critical problem that most all telework managers have today. With the present invention, management can now have total accountability for work knowing who did what, who should be doing what, whether they are doing things the correct way and within the time allotted.

The present invention gives managers command and control over people, processes and information while eliminating the need for meeting face to face. Moreover, it goes beyond the management of staff remotely, it creates knowledge centric organizations that never have to recreate the wheel and never lose organizational knowledge from retired or resigned staff It is a tool that helps management to see the whole picture, affording an opportunity to step back, see that all the pieces fit and make mid-course corrections when necessary. It allows management to review all current projects, or examine a specific one, and get a comprehensive view without leaving his or her desk. The present invention takes information and automatically creates reports. As work progresses, executives need to make quick and accurate decisions.

The present invention provides information needed to aid in this decision making process such as: (1) The status of each project. (2) Who has done work? (3) How much time has been spent on a project? (4) How much time any individual has spent on a particular project or task? (5) What remains to be done and who needs to do it.

Active monitoring enables management to assess programs and projects in such a way that they can respond quickly and proactively. Whenever the need arises, an executive can focus on any item or report for a detailed view. Knowing that business processes are tied to the workforce in regards to utilization and allocation, management can ensure carrying through the mission by monitoring that the right things are being accomplished the right way.

Corporate Vocabulary (described below) and templates (described below) provide the brain, the institutional memory, of your organization and organize it in a way that makes sense like an organization chart. While working with the present invention, a user can identify the SME's (subject matter experts) and capture their expertise put in into a process library for reuse and to be refined.

The process one goes through to store information is unique. Users on a project in a team within a division capture information into Tasks. This information is overlaid by Vocab Terms, which are tied to processes, which can be reused. Ultimately, the present invention is capturing explicit and tacit knowledge for reuse, thus building corporate intellectual bandwidth and empowering staff to do things they never knew how to do before.

Each Division in an organization can create vocab terms for their processes and categories. All vocab terms are stored in a common list called “Corporate Vocabulary,” making it easy to access vocab terms, as well as the vocab terms in other departments. Vocab terms can be assigned to projects, tasks, documents, and processes, and enabling user to find information and processes throughout the organization quickly and effectively.

When a project is frequently used it may be used to form a Template. Templates are the business processes and they can be reused and refined. They are displayed in the red, amber, green color-coded convention of a traffic light indicator, allowing management to view, at a glance, important processes and projects. Management can quickly dive into projects that are “RED” and resolve problems to get them back on track.

Access to all user information is the user's fingertips based upon organizational structure, teams and projects. From a smartphone or laptop, user just types what they are looking for and it appears but what's different is that the file is now surrounded by meaningful information about how it was produced. This mind-jogging process helps a user to think about other information they may need as well, thereby mentally taking them back to that point in time for total recall of all events. Whether working from the office, the client site or home, the user has access to all their projects, tasks and files. Vital work is always available for all team members when they need it. All team members enjoy authorized access to all files and notes associated with a project.

The present invention's versioning feature keeps an archive of previous file versions, so work is always available for comparison and allows the user to see changes to documents while preserving previous drafts.

Project plans normally require tasks to be performed in a specific order. For instance, a publication must be written and proofread before it can be printed. To achieve this, a Gantt chart application lets you link tasks so that they depend on each other. By default, tasks are usually linked in a ‘Finish to Start’ (“F-S”) relationship (dependency), which means that the first task you select (the predecessor task) must end before the next task you select (the successor task) can start, and so on. The present invention allows for automation of a Gantt chart with “Gantt” Chart notifications that control workflow. In using a F-S Link, when the “F” task A is completed, it will automatically notify the “S” task B that is it ok to start. A typical Gantt chart needs human intervention to control tasks; the present invention allows for automation of the Gantt chart and thus automation workflow.

### BRIEF DESCRIPTION OF THE DRAWINGS

FIG. 1. FIG. 1 is a flow chart of an exemplary process of the present invention.

FIG. 2. FIG. 2 is a schematic diagram of an exemplary embodiment of an organization chart that may use the present invention.

FIG. 3. FIG. 3 is a schematic diagram of the exemplary embodiment of the present invention.

### DETAILED DESCRIPTION

Broadly, an exemplary embodiment of the present invention generally provides a method to manage knowledge within an organization. More specifically, an exemplary embodiment of the present invention provides a computer-readable storage device storing a plurality of instructions which, when executed by a processor, cause the processor to perform operations for managing knowledge within an organization. In another embodiment, the present invention is an apparatus for managing knowledge within an organization, comprising: a processor; and a computer-readable storage device storing a plurality of instructions which, when executed by the processor, cause the processor to perform operations for managing knowledge within an organization.

Generally, the method for managing knowledge within the organization comprises creating asset record documents; creating process record documents; mining the asset record documents and process record documents to create a corporate vocabulary; creating assigned tasks based on corporate vocabulary; linking assigned tasks, asset record documents, and process record documents to people, keywords, departments, subject matter experts, employees, business divisions, activities or projects or combinations thereof; and tracking assigned tasks, asset record documents, and process record documents by employee responsibility, location, department, project or status or combinations thereof.

The asset is typically physical, financial, human, information, digital, intangible, secure or combinations thereof. An authorization component may be configured to determine whether people, keywords, departments, subject matter experts, employees, business divisions, activities or projects or combinations thereof, have sufficient credentials to access a document in the document library.

The present invention serves to build the intellectual bandwidth of the business using a multi-store model that is also known as the Atkinson-Shiffrin memory model. See Zlonoga, B.; Gerber, A. (February 1986). “A case from practice (49). Patient: K. F., born 6 May 1930 (bird fancier's lung)”. Schweiz. Rundsch. Med. Prax. 75 (7): 171-2. PMID 3952419

Existing systems may have information if users search them, but they may not have surrounding facts of how this information came from. In an exemplary embodiment of the present invention, everything is in a project that is dated so the organization knows the surrounding information and may make sense of the information.

An exemplary embodiment of the present invention may capture tacit knowledge of the subject matter expert, transform it into explicit knowledge, and use a project based operating system that creates a process library. The process in the library may be available to be used, reused, refined, or revised to build corporate intellectual bandwidth, even long after the original SME has moved on. The present invention may take users' information and transform it into knowledge that empowers others.

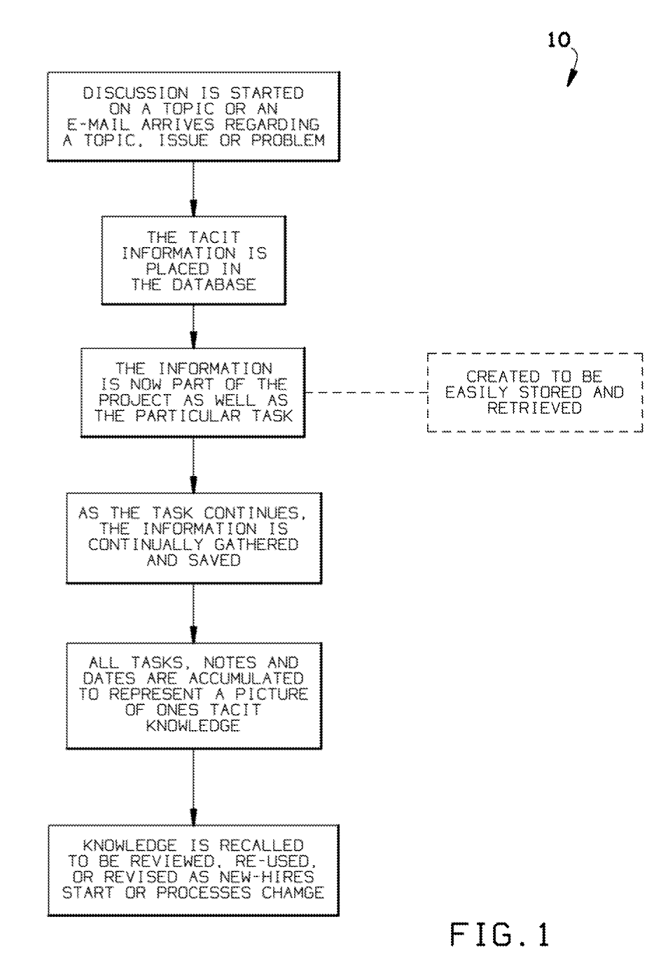

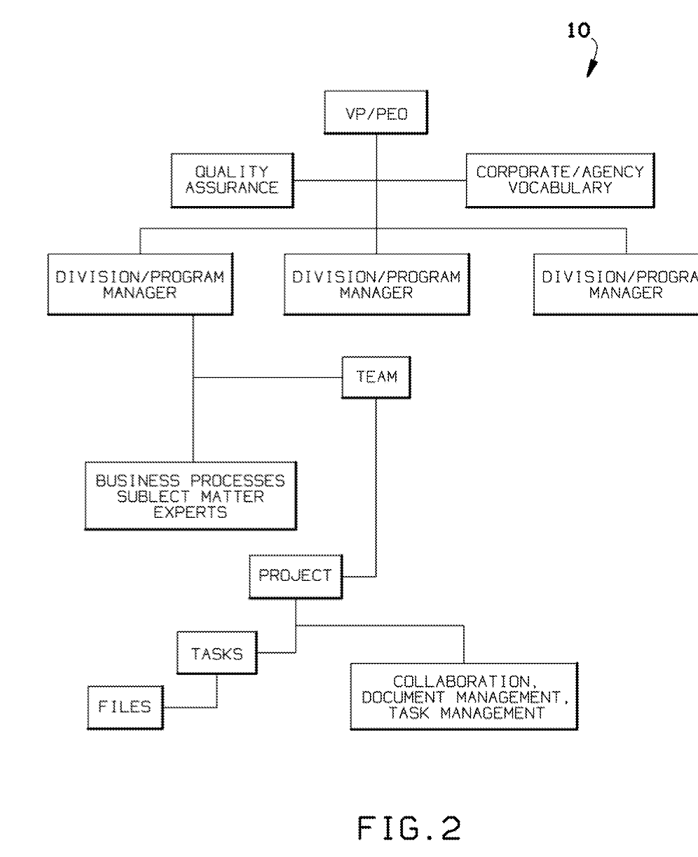

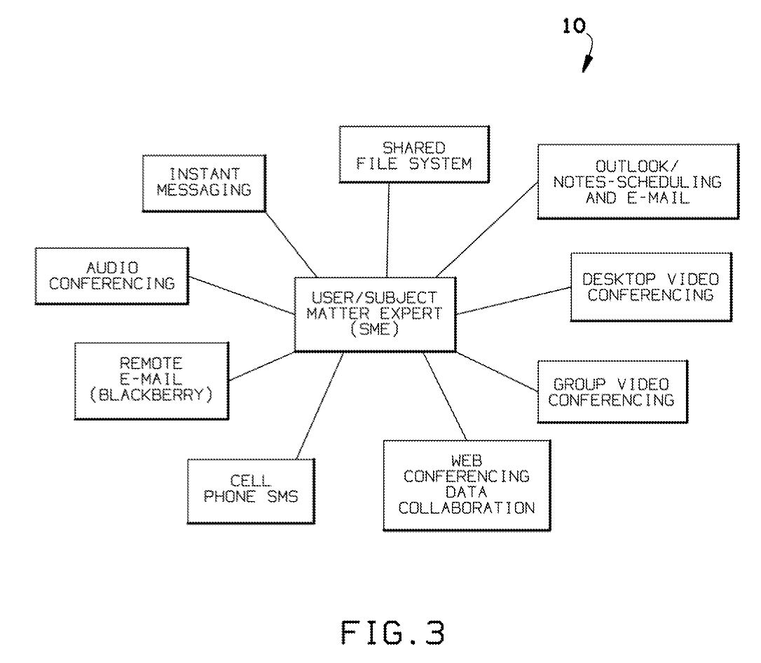

As shown in FIGS. 1-3, in one exemplary embodiment of the present invention, a computer readable medium may have computer usable program code embodied therewith. The computer program code has a computer program code configured to collect tacit information; computer program code configured to store the tacit information into a database; and computer program code configured to recall the tacit information from the database.

E-mails arrives in an e-mail box or a discussion is started on a topic, issue, or problem, an exemplary embodiment of the present invention may capture the information, e.g., tacit knowledge, for example, and put it into database. The information may be a part of a particular task within a project under a team within a division in an organization.

An exemplary embodiment of the present invention may be a part of a dated transaction in such a way to induce a thought process. More and more information may be captured as the day continues. Since everything is bundled around a project hierarchy, a recall may be achieved many ways but once found, surrounding tasks, notes, and dates may be cumulated to present a picture of tacit knowledge, which may be reused by others.

The present invention may be built in the same way as an organization chart is built. There may be a top-level leader, different divisions, team members, various projects or tasks, and files, for example. Information may be populated at a level and while it populates, it may build the institutional blueprint of corporate intellectual knowledge. These processes may become corporate assets in a general accepted accounting program (GAAP). The invention not only captures tacit knowledge but also allows for two or more parties to have a conversation yet never see each other and not have to conversation during the same time. The present invention threads a conversation and puts bookmarks on questions asked to the other party—so when the “other” party wants to take part in the conversation, he/she would be presented with the conversation but with bookmarks on where questions were asked. Like writing a book and when you ask questions, you leave blanks for answers - - - , these blanks stay there until the user answers them—and it can go on forever. The important thing to remember is that you are now having discussions with many and you never miss a beat as the present invention treats a discussion as a timed transaction three days ago the question was asked—you intervene at that point you don't have to read backwards (although you could). This is encapsulated in the present invention's unique architecture that captures tacit knowledge similar to how the human brain works.

Projects and tasks may be mapped to capture tacit knowledge and may be stored into unique database structure for retrieval. Unique database structure may be created into different tiers and may be named divisions where organized processes are created and mapped.

An exemplary embodiment of the present invention may transform information into different levels. The SME may include shared file system, outlook/notes-scheduling and e-mails, desktop video conferencing, group video conferencing, web conferencing, web conferencing data collaboration, cell phone short message system (SMS), remote e-mail, audio conferencing, and instant messaging, for example. Most information may be one's tacit knowledge and it may be captured for reuse by others.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for managing knowledge within an organization comprising:
a. Creating asset record documents;
b. Creating process record documents;
c. Mining the asset record documents and process record documents to create a corporate vocabulary;
d. Creating assigned tasks based on corporate vocabulary;
e. Linking assigned tasks, asset record documents, and process record documents to people, keywords, departments, subject matter experts, employees, business divisions, activities or projects or combinations thereof; and
f. Tracking assigned tasks, asset record documents, and process record documents by employee responsibility, location, department, project or status or combinations thereof.

2. The method of claim 1 wherein the asset is physical, financial, human, information, digital, intangible, secure or combinations thereof.

3. The method of claim 1 further comprising assigning each document a unique number printed on the document.

4. The method of claim 3 further comprising searching and recalling a document based on the unique number.

5. The method of claim 1 further comprising automatically filing emails and attached sent by people, keywords, departments, subject matter experts, employees, business divisions, activities or projects or combinations thereof, into the asset record document or process record document based on assigned tasks.

6. The method of claim 1 further comprising configuring an authorization component to determine whether people, keywords, departments, subject matter experts, employees, business divisions, activities or projects or combinations thereof, have sufficient credentials to access a document.

7. The method of claim 1 wherein the documents, corporate vocabulary and assigned tasks may be viewed or accessed through a Web based portal.

8. The method of claim 1 further comprising configuring an automation component wherein when a predecessor assigned task must end before a successor assigned task can start, when the predecessor assigned task is completed an automatic notification is created that the successor assigned task may be initiated.

9. The method of claim 1 further comprising generating email and text alerts and reports based on asset records, process records or assigned tasks.

10. A computer-readable storage device storing a plurality of instructions which, when executed by a processor, cause the processor to perform operations for managing knowledge within an organization, the operations comprising:
a. Creating asset record documents;
b. Creating process record documents;
c. Mining the asset record documents and process record documents to create a corporate vocabulary;
d. Creating assigned tasks based on corporate vocabulary;
e. Linking assigned tasks, asset record documents, and process record documents to people, keywords, departments, subject matter experts, employees, business divisions, activities or projects or combinations thereof; and
f. Tracking assigned tasks, asset record documents, and process record documents by employee responsibility, location, department, project or status or combinations thereof.

11. The computer-readable storage device of claim 10 wherein the asset is physical, financial, human, information, digital, intangible, secure or combinations thereof.

12. The computer-readable storage device of claim 10 further comprising assigning each document a unique number printed on the document.

13. The computer-readable storage device of claim 12 further comprising searching and recalling a document based on the unique number.

14. The computer-readable storage device of claim 10 further comprising automatically filing emails and attached sent by people, keywords, departments, subject matter experts, employees, business divisions, activities or projects or combinations thereof, into the asset record document or process record document based on assigned tasks.

15. The computer-readable storage device of claim 10 further comprising configuring an authorization component to determine whether people, keywords, departments, subject matter experts, employees, business divisions, activities or projects or combinations thereof, have sufficient credentials to access a document.

16. The computer-readable storage device of claim 10 wherein the documents, corporate vocabulary and assigned tasks may be viewed or accessed through a Web based portal.

17. The computer-readable storage device of claim 10 further comprising configuring an automation component wherein when a predecessor assigned task must end before a successor assigned task can start, when the predecessor assigned task is completed an automatic notification is created that the successor assigned task may be initiated.

18. The computer-readable storage device of claim 10 further comprising generating email and text alerts and reports based on asset records, process records or assigned tasks.

19. An apparatus for managing knowledge within an organization, comprising: a processor; and a computer-readable storage device storing a plurality of instructions which, when executed by the processor, cause the processor to perform operations, the operations comprising:
a. Creating asset record documents;
b. Creating process record documents;
c. Mining the asset record documents and process record documents to create a corporate vocabulary;
d. Creating assigned tasks based on corporate vocabulary;
e. Linking assigned tasks, asset record documents, and process record documents to people, keywords, departments, subject matter experts, employees, business divisions, activities or projects or combinations thereof; and
f. Tracking assigned tasks, asset record documents, and process record documents by employee responsibility, location, department, project or status or combinations thereof.
